(19) United States
(12) Patent Application Publication
(10) Pub. No.: US 2024/0239599 A1
(43) Pub. Date: Jul. 18, 2024

(54) WASTE APPARATUS AND HANDLING METHOD

(71) Applicants: Oren MARIONOVSKY, Modiin (IL); Adi MARIONOVSKY, Beer-Sheva (IL); Chen AHARON, Beer-Sheva (IL)

(72) Inventors: Oren MARIONOVSKY, Modiin (IL); Adi MARIONOVSKY, Beer-Sheva (IL); Chen AHARON, Beer-Sheva (IL)

(21) Appl. No.: 18/097,305

(22) Filed: Jan. 16, 2023

(51) Int. Cl. B65F 1/00; B08B 3/02; B65F 1/14; B65F 7/00

(52) U.S. Cl. CPC B65F 1/004; B08B 3/02; B65F 1/1405; B65F 7/00; B65F 2210/169; B65F 2210/183

(57) ABSTRACT

A waste apparatus, including a first compartment for manually inserting waste thereinto from the environment, a second compartment being discardable, for discarding the second compartment while containing the waste, and a processing device including a transfer device, for transferring the waste from the first compartment to second compartment, and for then partitioning the first compartment from the second compartment, thereby the waste is stored within the second compartment separated from the environment, for allowing delaying the discarding the second compartment while containing the waste.

### TECHNICAL FIELD

The invention relates to the field of waste handling.

### BACKGROUND

Conventionally waste is inserted into a bag, and discarded together with the bag upon being filled.

However, the user must repeat the discarding again and again.

Shredding for delaying the discarding raises a problem of odors produced by the shredded waste.

There is a long felt need to provide a solution to the above-mentioned and other problems of the prior art.

### SUMMARY

A waste apparatus, including:
a first compartment;
a second compartment being discardable; and
a processing device.

### BRIEF DESCRIPTION OF THE DRAWINGS

Embodiments, features, and aspects of the invention are described herein in conjunction with the following drawings:

FIG. 1 depicts the first step of the operation of a waste apparatus according to one embodiment of the invention.

FIG. 2 depicts the second step of the operation of the waste apparatus of FIG. 1.

FIG. 3 depicts the third step of the operation of the waste apparatus of FIG. 1.

FIG. 4 depicts the fourth step of the operation of the waste apparatus of FIG. 1.

FIG. 5 depicts the fifth step of the operation of the waste apparatus of FIG. 1.

FIG. 6 describes the first step of the fifth step of FIG. 5.

FIG. 7 describes the first step of the fifth step of FIG. 5.

FIG. 8 depicts the sixth step of the operation of the waste apparatus of FIG. 1.

FIG. 9 details the sixth step of FIG. 8.

FIG. 10 depicts the seventh step of the operation of the waste apparatus of FIG. 1.

FIG. 11 details the seventh step of FIG. 10.

FIG. 12 depicts the eighth step of the operation of the waste apparatus of FIG. 11.

FIG. 13 depicts the ninth step of the operation of the waste apparatus of FIG. 1.

FIG. 14 is a perspective view of the waste apparatus of FIG. 1.

FIG. 15 depicts the bottom of the waste apparatus of FIG. 1.

FIG. 16 depicts the bottom of the waste apparatus of FIG. 1 describing the assembling of the bag.

FIG. 17 is a rear sectional view of the waste apparatus of FIG. 1.

The drawings are not necessarily drawn to scale.

### DETAILED DESCRIPTION

The invention will be understood from the following detailed description of embodiments of the invention, which are meant to be descriptive and not limiting. For the sake of brevity, some well-known features are not described in detail.

The reference numbers have been used to point out elements in the embodiments described and illustrated herein, in order to facilitate the understanding of the invention. They are meant to be merely illustrative, and not limiting. Also, the foregoing embodiments of the invention have been described and illustrated in conjunction with systems and methods thereof, which are meant to be merely illustrative, and not limiting.

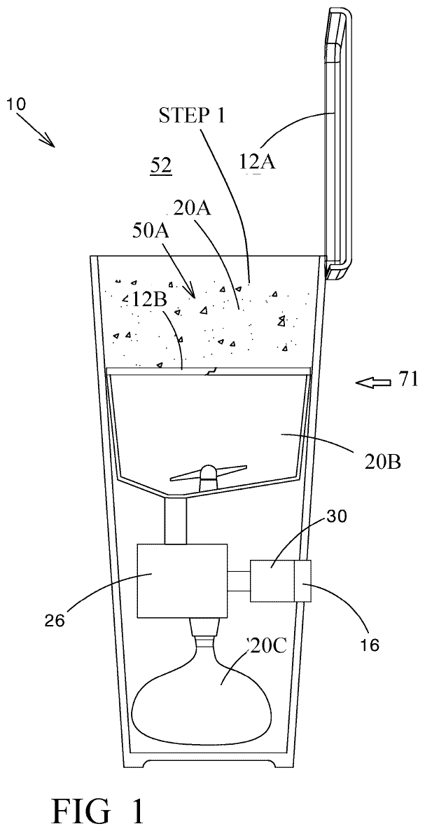

FIG. 1 depicts the first step of the operation of a waste apparatus according to one embodiment of the invention.

A waste apparatus 10 according to the invention includes a top compartment 20A including a manually openable roof 12A and an openable floor 12B.

At the first step, being while openable floor 12B is open, the user manually opens top compartment 20A, inserts waste 50A thereinto, and then closes top compartment 20A, several times.

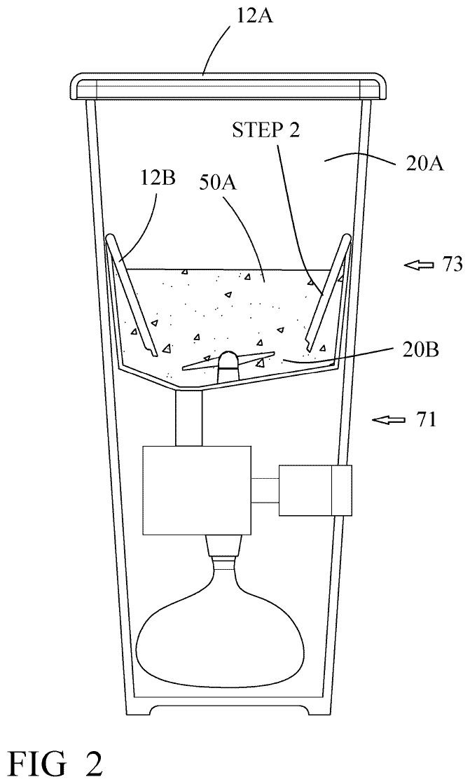

FIG. 2 depicts the second step of the operation of the waste apparatus of FIG. 1.

At the second step being once top compartment 20A is full or before being full or upon manual operation, openable floor 12B is being opened, thus functioning as a transfer device 73, thus waste 50A falls from top compartment 20A into a middle compartment 20B by gravity.

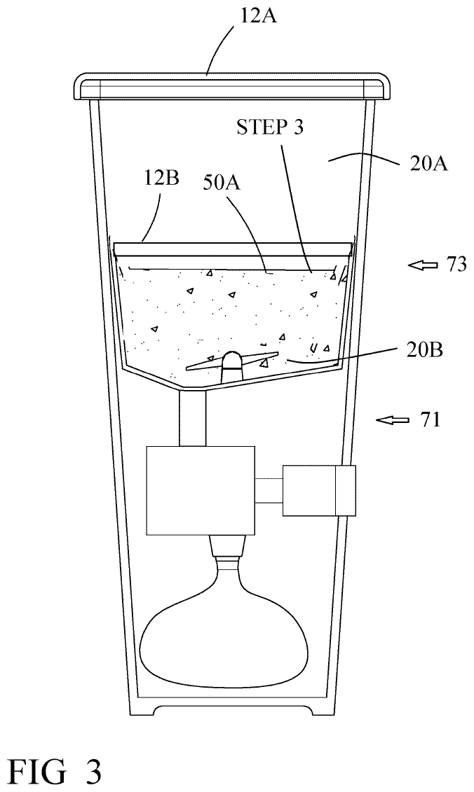

FIG. 3 depicts the third step of the operation of the waste apparatus of FIG. 1.

At the third step, roof 12A is closed, thus showing the top of middle compartment 20B. Middle compartment 20B is full.

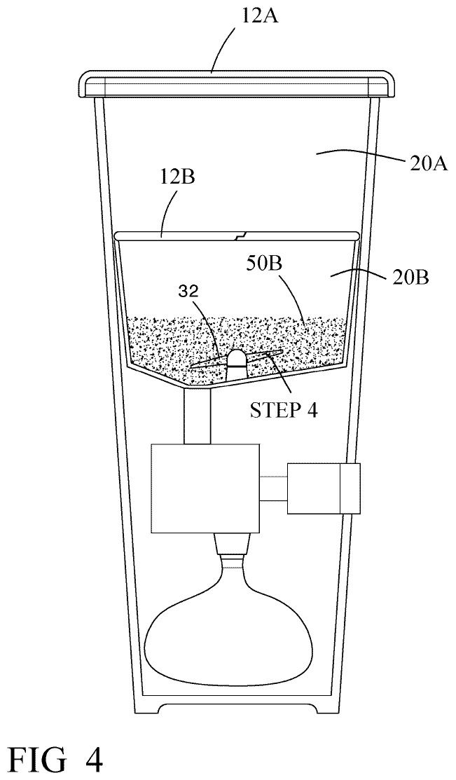

FIG. 4 depicts the fourth step of the operation of the waste apparatus of FIG. 1.

At the fourth step, a shredder 32 shreds waste 50A of FIG. 3, turning it to shredded waste 50B thus diminishing it to decrease the space occupation, thus middle compartment 20B is half empty.

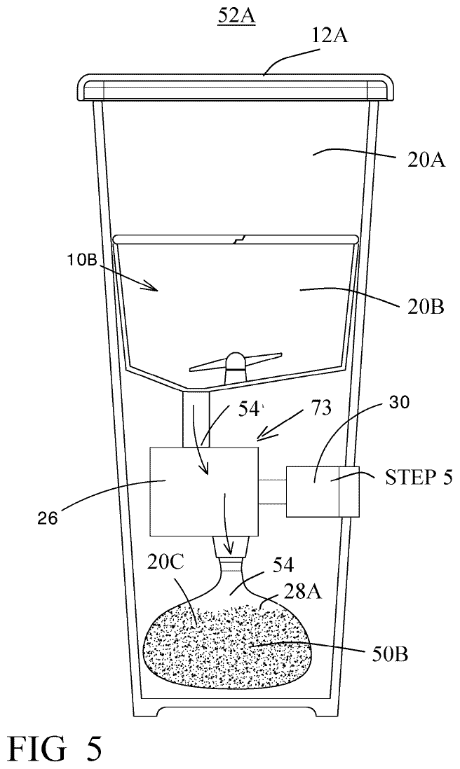

FIG. 5 depicts the fifth step of the operation of the waste apparatus of FIG. 1.

At the fifth step, a pump 30 pumps shredded waste 50B, and a directing device 26 directs shredded waste 50B from middle compartment 20B to a bottom compartment 20C, being separated from middle compartment 20B, thus consequently, opening of roof opening 12 does not expose undesired odors of shredded waste 50B to the top environment 52A.

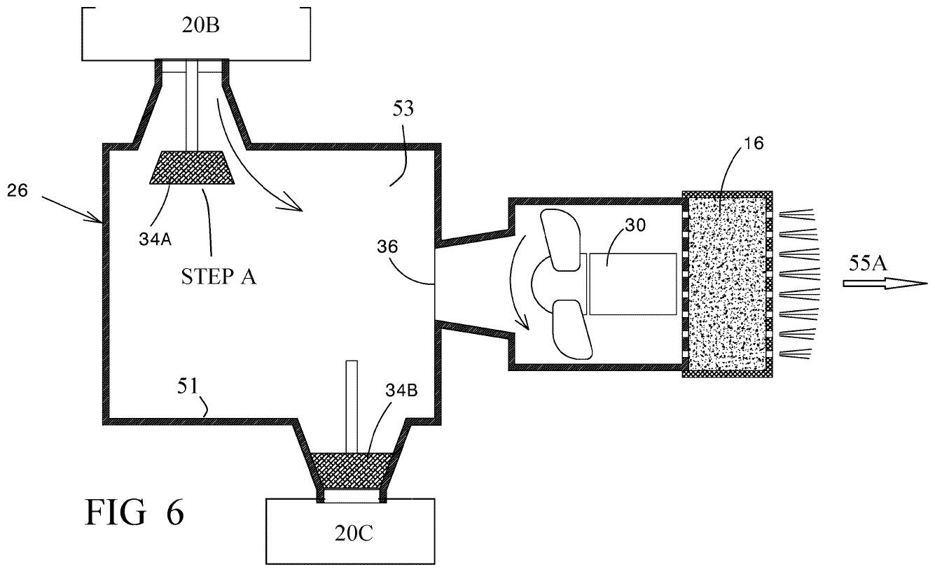

FIG. 6 describes the first step of the fifth step of FIG. 5.

According to one embodiment, directing assembly constitutes a compartment 53 including a top valve 34A being openable to middle compartment 20B; a bottom valve 34B being openable to bottom compartment 20C; and a side opening 36 being opened to pump 30.

At the first step (“step A”) of the fifth step, top valve 34A is open and bottom valve 34B is closed, and pump 30 rotates to draw air (55A) out of compartment 53. Thus, pump 30 draws shredded waste 50B out of middle compartment 20B onto the floor 51 of compartment 53.

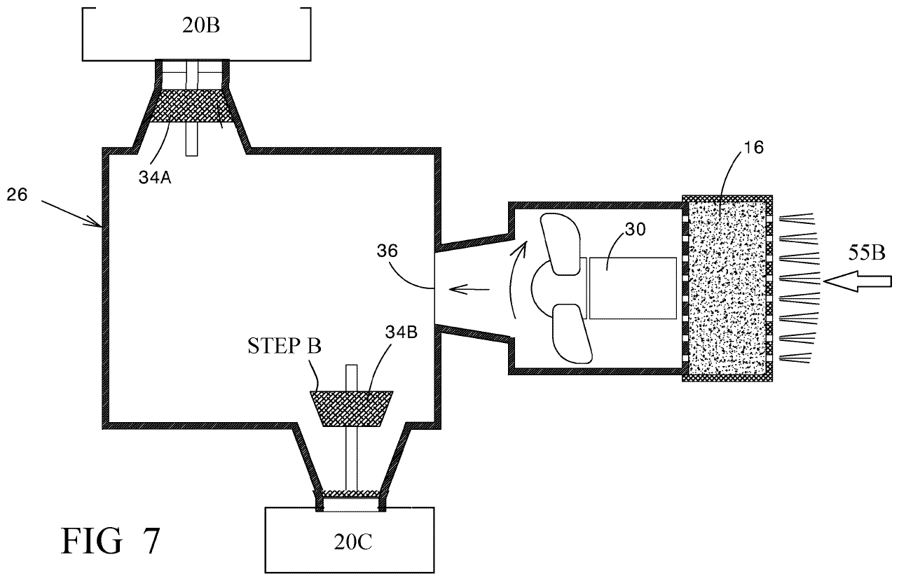

FIG. 7 describes the first step of the fifth step of FIG. 5.

At the second step (“step B”) of the fifth step, top valve 34A is closed and bottom valve 34B is open, and pump 30 rotates to insert air (55B) into compartment 53. Thus, pump 30 presses shredded waste 50B from floor 51 of compartment 53 to bottom compartment 20C.

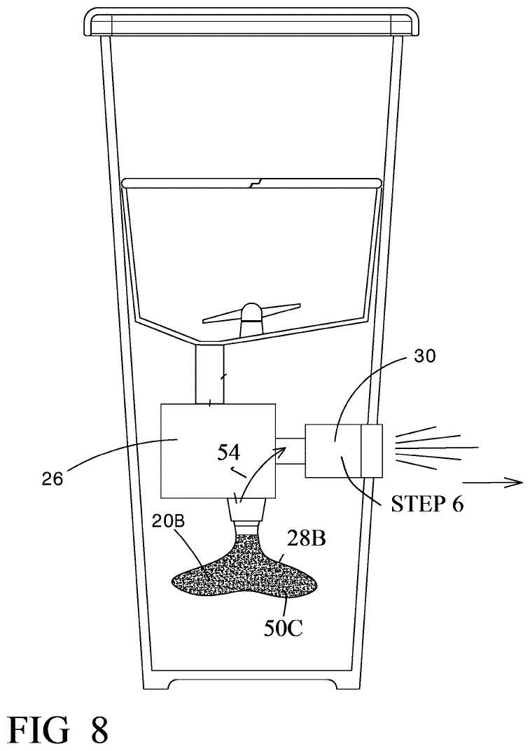

FIG. 8 depicts the sixth step of the operation of the waste apparatus of FIG. 1.

Bottom compartment 20C is shrinkable, e.g., constitutes a shrinkable disposable bag.

At the sixth step, pump 30 or another pump deflates bottom compartment 20C, thus bottom compartment 20C shrinks from size 28A of FIG. 5 to size 28B of FIG. 6, thus presses shredded waste 50B, thus turning it to shredded compressed waste 50C.

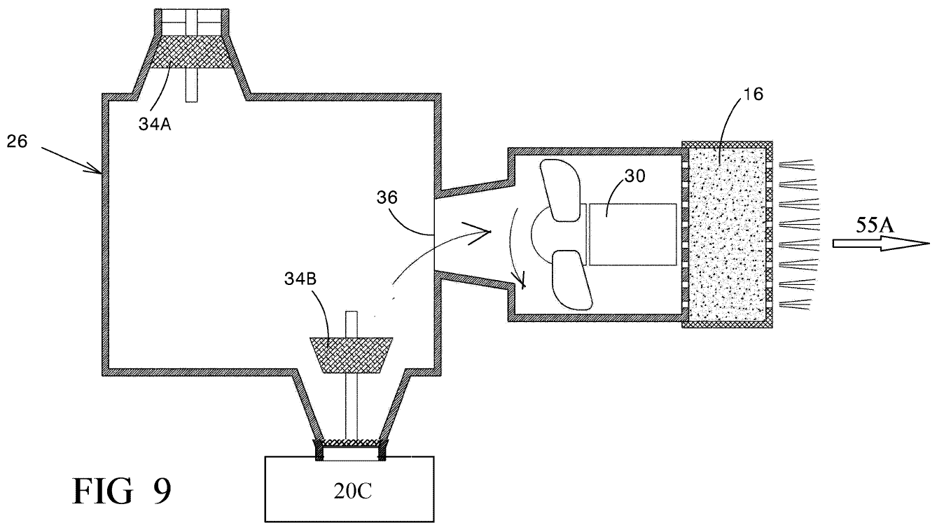

FIG. 9 details the sixth step of FIG. 8.

The sixth step of FIG. 8 is obtained by closing top valve 34A, by opening bottom valve 34B, and by rotating pump 30 to draw air (55A) out of compartment 53.

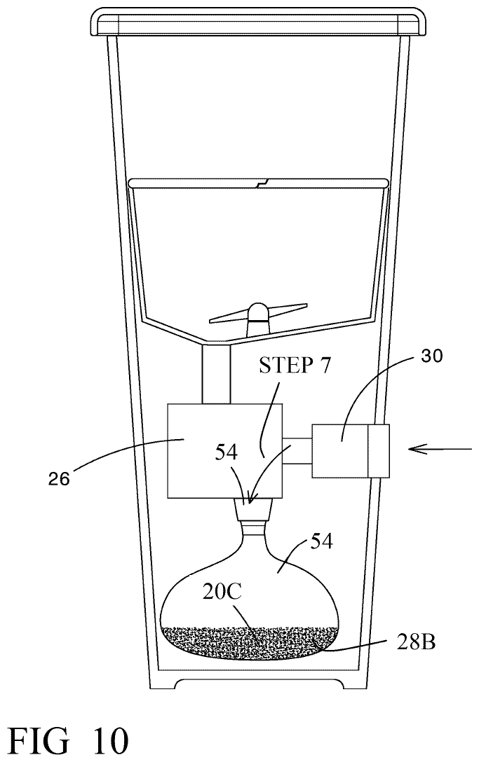

FIG. 10 depicts the seventh step of the operation of the waste apparatus of FIG. 1.

At the seventh step, pump 30 inserts air 54 into bottom compartment 20C to inflate it. Shredded compressed waste 50C remains having size 28B, thus providing additional space of air to bottom compartment 20C.

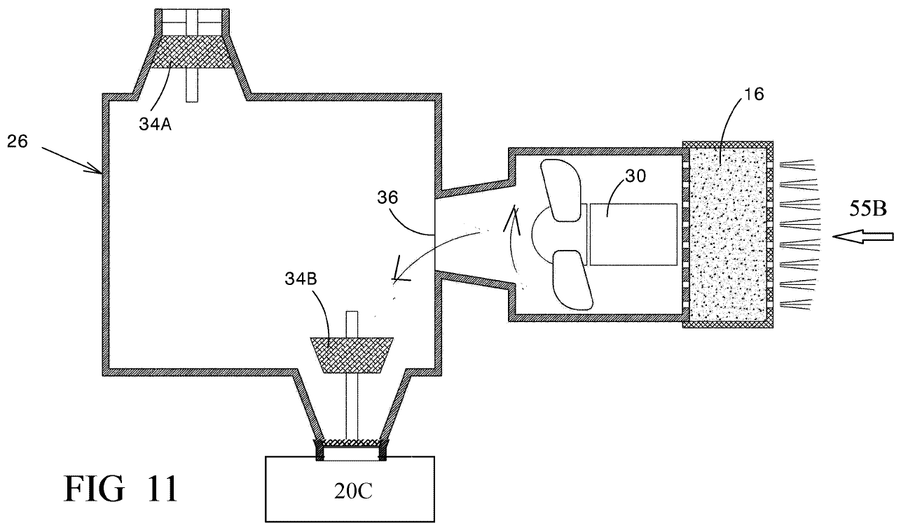

FIG. 11 details the seventh step of FIG. 10.

The seventh step of FIG. 10 is obtained by closing top valve 34A, by opening bottom valve 34B, and by rotating pump 30 to insert air (55B) into compartment 53.

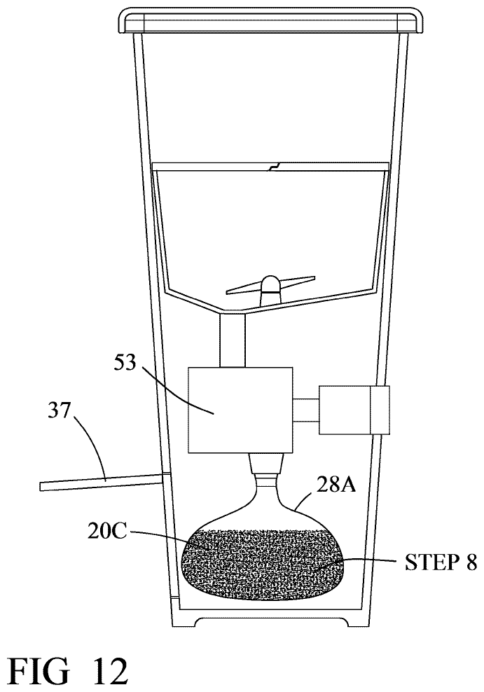

FIG. 12 depicts the eighth step of the operation of the waste apparatus of FIG. 11.

The eighth step includes repeating step 1 to 7 several times to fill bottom compartment 20C, until bottom compartment 20C contains shredded compressed waste 50C of size 28A.

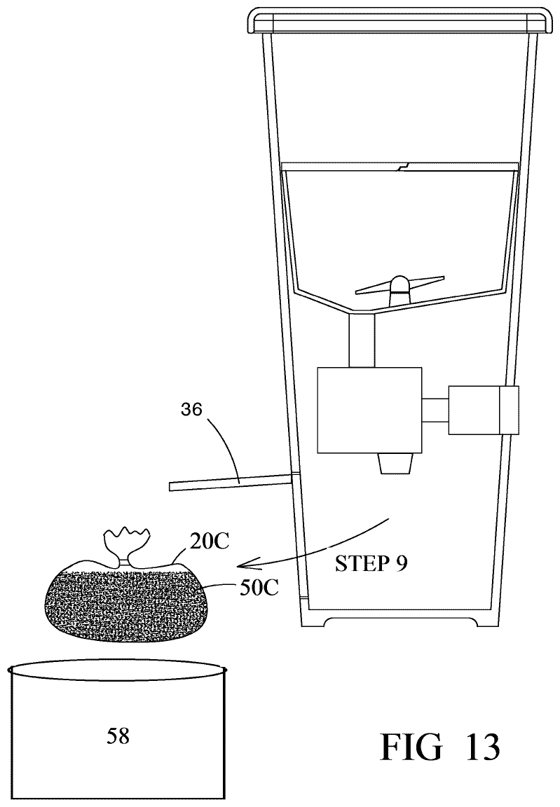

FIG. 13 depicts the ninth step of the operation of the waste apparatus of FIG. 1.

At the ninth step bottom compartment 20C, being typically a bag is removed to a waste bin 58.

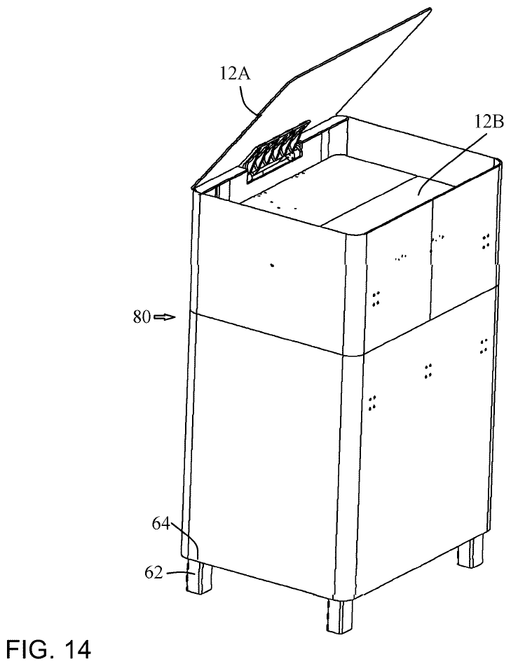

FIG. 14 is a perspective view of the waste apparatus of FIG. 1.

Package 80 of compartments 20A,20B and 20C includes legs 62 including weighing scales 62.

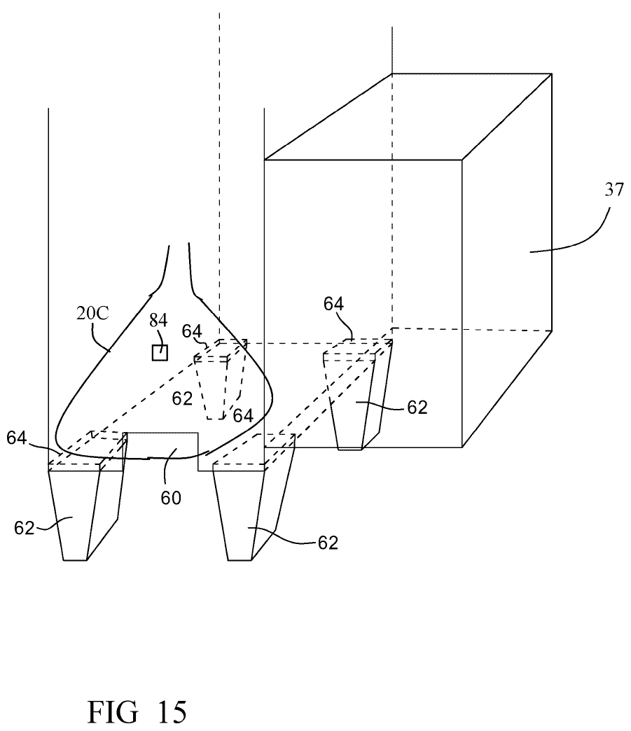

FIG. 15 depicts the bottom of the waste apparatus of FIG. 1.

The weight of bag 20C is measured by weighing scales 62, and upon exceeding a certain weight, door or drawer 37 is opened for removing bag 20C.

An infra-red detector 60 may detect presence of trash bag 20C.

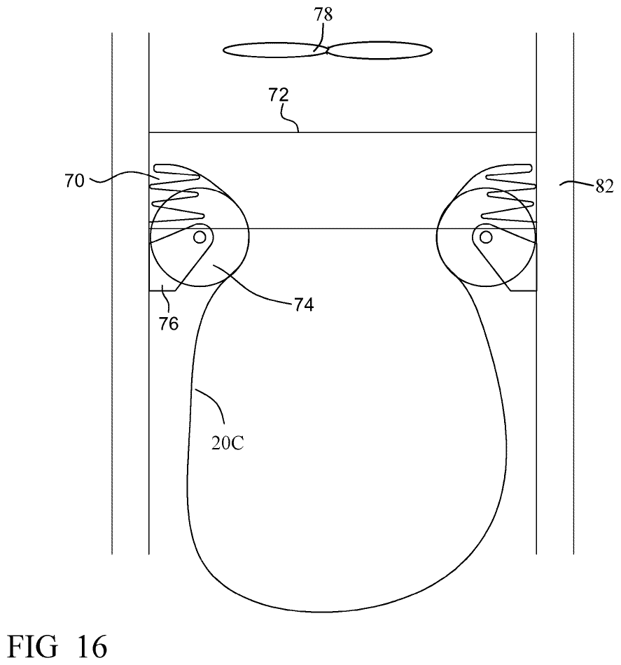

FIG. 16 depicts the bottom of the waste apparatus of FIG. 1 describing the assembling of the bag.

Trash bag 20C may be folded (70) inside a disposable cardboard cartridge 72. Rollers 74 together with a fan 78 deploy trash bag 20C from cartridge 72. Rollers 74 are rotate about brackets 76, which hang and seal bag 20C.

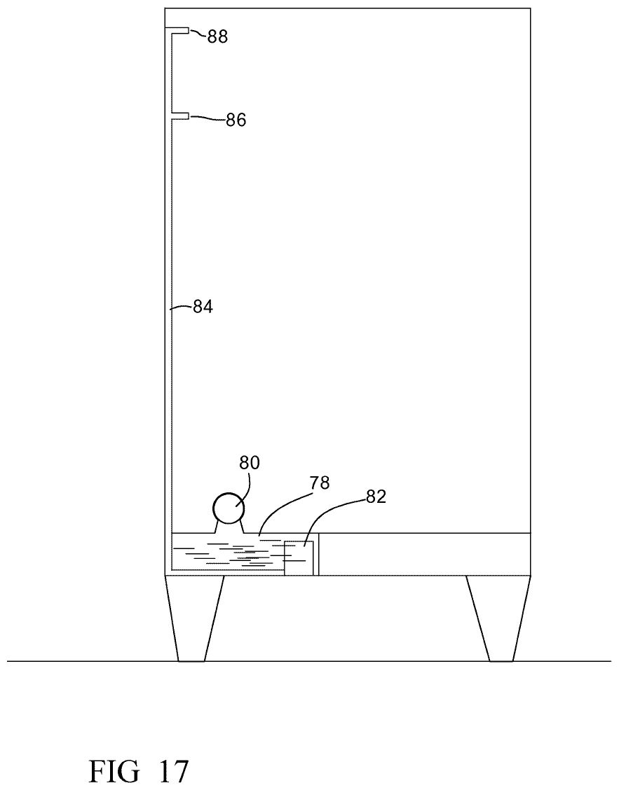

FIG. 17 is a rear sectional view of the waste apparatus of FIG. 1.

A water tank 78 is disposed at the bottom of package 80. Water tank 78 includes a filling opening 80.

A water pump 82 is disposed within water tank 78 for lifting the water upwards through a pipe 84.

Nozzle 86 of pipe 84 is used to clean shredder 32; and nozzle 88 is used to clean openable roof 12A.

New bags will be supplied in in a tough cardboard holder. Middle oval shaped area will be a hole and we store the bags on the outer area. When reloading of the bag is set, the user must remove the garbage first. The system will not allow user to load a new set of bags without removing the garbage bag. This ensures correct bag counting. Once a bag is absent, it will be notified and then user must remove the garbage first. And then the old bag container will come down and come out with the drawer 37 so user can replace the bags. Once the bags are loaded the drawer 37 will close, automatic loading process will start. When drawer 37 is closed the system will pull up the bag container towards the grinding rolls. The bag container will come up using the rails placed in package 80. The sealing system will be placed on the bottom of the bag container.

The weight of the bags together with the weight of the garbage are supported by the 4 rolls 74 installed on the four sides, beneath the bag container. There will be same kind of rolls in grinder level and when the bag container goes up, the bags are tightened between the rolls 74, sufficiently to hold 10 kg of weight, for example. Rolls 74 are supported by brackets 76. Fans 78 on the grinder level open the bags wider. Volume sensor 84 are disposed at the same height of fans 78 to open the bags. Waster apparatus 10 includes a sealing and cutting mechanism, including a cutting heat coil and a sealing heat coil. Whenever the user removes a bag, these two coils will come together and one coil will seal the bag while the other coil cuts the bag. A proximity sensor supplies the opposite sealing bar.

Thus, in one aspect, the invention is directed to a waste apparatus (10), including:
a first compartment (20A) for manually inserting waste (50A) thereinto from the environment (52A);
a second compartment (20C) being discardable, for discarding the second compartment (20C) while containing the waste (50A); and
a processing device (71) including a transfer device (73), for transferring the waste (50A) from the first compartment (20A) to second compartment (20C), and for then partitioning (12B) the first compartment (20A) from the second compartment (20C),
   thereby the waste (50A) is stored within the second compartment (20C) separated from the environment (52A), for allowing delaying the discarding the second compartment (20C) while containing the waste (50A).

The processing device (71) may further include a waste diminishing device (32,30), thereby the waste (50A) stored within the second compartment (20C) separated from the environment (52A) is diminished (50B,50C), thereby allowing plural transfers of the waste (50A) to second compartment (20C) for each discarding thereof.

The waste diminishing device (32,30) may include a shredder (32).

The waste diminishing device (32,30) may include an air deflating device (30), for deflating the second compartment (20C) onto the waste (50A), thereby to diminish the waste (50A).

The waste diminishing device (32,30) may include an air inflating device (30), for inflating (54) the second compartment (20C) for providing empty space to add waste.

The waste diminishing device (32,30) may include:
an air pump (30); and
an air directing device (26) including a compartment (53) including at least one valve (34A).

In another aspect, the invention is directed to a waste handling method, including the steps of:
providing a first compartment (20A), for manually inserting waste (50A) thereinto from the environment (52A);
providing a second compartment (20C) being discardable;
transferring the waste (50A) from the first compartment (20A) to the second compartment (20C);
upon the transferring, partitioning (12B) the first compartment (20A) from the second compartment (20C), thereby the waste (50A) is stored within the second compartment (20C) separated from the environment (52A); and
upon the partitioning (12B), allowing discarding the second compartment (20C) while containing the waste (50A),
   thereby the separation of the waste (50A) from the environment (52A) allows delaying the discarding of second compartment (20C) while containing the waste (50A).

The step of transferring the waste (50A) from the first compartment (20A) to the second compartment (20C) may include shredding (32) the waste (50A), thereby allowing plural transfers of shredded waste (50B) to second compartment (20C) for each discarding thereof.

The waste handling method may further include the steps of:
upon the partitioning (12B) and prior to the discarding, deflating the second compartment (20C), for diminishing the waste (50A) contained; and
inflating (54) the second compartment (20C), for adding space to the second compartment (20C), for adding waste.

The waste handling method may further include the steps of:
upon the partitioning (12B) and prior to the discarding, deflating the second compartment (20C), for diminishing the shredded waste (50B) contained; and
inflating the second compartment (20C), for adding space to the second compartment (20C), for adding shredded waste.

In the figures and/or description herein, the following reference numerals (Reference Signs List) have been mentioned:
numeral 10 denotes the waste apparatus according to one embodiment of the invention;
12A: openable roof;
12B: openable floor functioning as a partition between compartment 20A and 20B, thereby between compartment 20A and 20C;
16: filter for allowing air flow and not allowing flow of waste therethrough;
20A: top compartment;
20B: middle compartment;
20C: bottom compartment, preferably being a disposable bag;
26: air directing device;
28A,28B: amount of waste contained in compartment 20C forming the size thereof;
30: air pump or vacuum producer;
32: shredder;
34A,34B: valves;
36: side opening of compartment 53;
37: door or drawer for removing bottom bag 20C from compartment 53, thus from top compartment 20A;
50A: waste inserted by the user;
50B: shredded waste;
50C: waste pressed by vacuum;
51: floor of compartment 53;
52: environment;
53: compartment of air directing device;
54: air flow including for inflating and deflating;
55A: drawing air from compartment 53;
55B: pumping air into compartment 53;
58: waste bin;
71: waste processing device, which may include middle compartment 20B, shredder 32, pump 30, and air directing device 26;
73: transfer device, including openable floor 12B and pump 30 and air directing device 26;
84: volume sensor;
The foregoing description and illustrations of the embodiments of the invention have been presented for the purpose of illustration, and are not intended to be exhaustive or to limit the invention to the above description in any form.

Any term that has been defined above and used in the claims, should be interpreted according to this definition.

The reference numbers in the claims are not a part of the claims, but rather used for facilitating the reading thereof. These reference numbers should not be interpreted as limiting the claims in any form.

What is claimed is:

1. A waste apparatus, comprising:
a first compartment for manually inserting waste thereinto from an environment;
a second compartment being discardable, for discarding said second compartment while containing said waste; and
a processing device comprising a transfer device, for transferring said waste from said first compartment to said second compartment, and for then partitioning said first compartment from said second compartment,
thereby said waste is stored within said second compartment separated from said environment, for allowing delaying said discarding said second compartment while containing said waste.

2. The waste apparatus according to claim 1, wherein said processing device further comprises a waste diminishing device,
thereby said waste stored within said second compartment separated from said environment is diminished,
thereby allowing plural transfers of said waste to second compartment for each discarding thereof.

3. The waste apparatus according to claim 2, wherein said waste diminishing device comprises a shredder.

4. The waste apparatus according to claim 1, further comprising a water pump for cleaning at least said first compartment.

5. The waste apparatus according to claim 2, wherein said waste diminishing device comprises an air deflating device, for deflating said second compartment onto said waste, thereby to diminish said waste.

6. The waste apparatus according to claim 2, wherein said waste diminishing device comprises an air inflating device, for inflating said second compartment for providing empty space to add waste.

7. The waste apparatus according to claim 2, wherein said waste diminishing device comprises:
an air pump; and
an air directing device comprising a compartment comprising at least one valve.
